(19) United States
(12) Patent Application Publication
(10) Pub. No.: US 2003/0036373 A1
(43) Pub. Date: Feb. 20, 2003

(54) RF mixer using half local oscillation frequency

(76) Inventors: Hyun Kyu Yu, Taejon (KR); Nam-Soo Kim, Seoul (KR); Yong-Sik Youn, Taejon (KR); Pil Jae Park, Gyeongsan-Si (KR)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/032,725

(22) Filed: Dec. 27, 2001

(30) Foreign Application Priority Data
Aug. 7, 2001 (KR) 2001-47549

(51) Int. Cl. H04B 1/26

(52) U.S. Cl. 455/333; 455/325

(57) ABSTRACT

The present invention relates to a frequency mixer utilized in a transceiver of radio frequency band. The frequency mixer for a radio frequency transceiver, includes two NMOS transistors, which are commonly connected, for generating a mixed signal combined with even harmonics, wherein a first end of the NMOS transistors is input a radio frequency signal, a second end of the NMOS transistors outputs the mixed signal, and gates of the NMOS transistors receive differential signals of local oscillator. The frequency mixer needs only half local oscillation frequency and a fundamental frequency of local oscillator is not presented. Therefore, the present invention can prevent generation of DC Voltage offset and also reduce frequency of local oscillator by half when it is utilized in a heterodyne transceiver.

### FIELD OF THE INVENTION

The present invention relates to a frequency mixer; and, more particularly, to a frequency mixer using a half local oscillation frequency, which is used for a wireless transceiver.

### DESCRIPTION OF RELATED ART

Generally, a frequency mixer is a circuit for converting a radio frequency to a low frequency or a low frequency to a radio frequency. The frequency mixer is used as a part of a super heterodyne type transceiver, which receives a radio frequency and outputs an intermediate frequency signal as an input by using it's nonlinear characteristic. The intermediate frequency is a difference between the radio signal and the local oscillator signal.

For obtaining the intermediate frequency signal, which is a difference between two super high frequency signals, nonlinear voltage-current characteristics are necessary. Such a circuit element with nonlinear voltage-current characteristic is applied to not only a frequency mixer but also a radio frequency circuit including a voltage controlled oscillator (VCO), a modulator and a frequency multiplier.

In general, heterodyne transceivers have a problem of image frequency due to an intermediate frequency. For eliminating the problem, the transceiver needs additional elements such as an image eliminating filter and an intermediate frequency mixer. Therefore, it causes increasing a price and consumption of electricity of a transceiver. It also gives a difficulty for integration of circuit.

For eliminating above-mentioned problem, a Homodyne transceiver is used. However, in case of utilizing N type MOSFET to a mixer, it needs to use whole frequency of the local oscillator for mixing frequencies. Therefore, an unnecessary DC voltage offset is generated causing by self-mixing. In case of utilizing an anti-parallel connection frequency mixer, it also has a DC voltage offset problem causing by representing a fundamental frequency of local the oscillation frequency.

FIG. 1A is a schematic diagram of a conventional frequency mixer using an N type MOSFET.

Referring to FIG. 1A, the frequency mixer includes a first, second NMOS transistors and a third, fourth NMOS transistors. The first and second NMOS transistors output an intermediate frequency signals V_{IF}⁺, V_{IF}⁻, wherein a commonly connected source is a positive (+) voltage V_{LO}⁺ of a local oscillator signal, gates receive the positive (+) voltage V_{rf}⁺ of radio frequency, and drains output intermediate frequency signals V_{IF}³⁰ , V_{IF}⁻. The third, fourth NMOS output an intermediate frequency signal V_{IF}⁺, V_{IF}⁻, wherein a commonly connected source receives a positive (−) voltage V_{LO}⁻ of local oscillator signal, gates receive a negative (−) voltage V_{rf}⁻ of a radio frequency, and drains output intermediate frequency signals V_{IF}⁺, V_{IF}⁻. If we assume IDS1, IDS2, IDS3 and IDS4 are currents flowing through each NMOSFET then each current may be written as follow:

$$\begin{matrix}{I}_{DS , 1} = {β}_{1} ( {V}_{RF}^{+} - {V}_{LO , D C} - {V}_{Tn , 1} - \frac{{V}_{LO}^{+} - {V}_{LO , D C}}{2} ) \\ ( {V}_{LO}^{+} - {V}_{LO , D C} ) , \\ {I}_{DS , 2} = {β}_{2} ( {V}_{RF}^{-} - {V}_{LO , D C} - {V}_{Tn , 2} - \frac{{V}_{LO}^{+} - {V}_{LO , D C}}{2} ) \\ ( {V}_{LO}^{-} - {V}_{LO , D C} ) ,\end{matrix} \\ \begin{matrix}{I}_{DS , 3} = {β}_{3} ( {V}_{RF}^{+} - {V}_{LO , D C} - {V}_{Tn , 3} - \frac{{V}_{LO}^{+} - {V}_{LO , D C}}{2} ) \\ ( {V}_{LO}^{-} - {V}_{LO , D C} ) , \\ {I}_{DS , 4} = {β}_{4} ( {V}_{RF}^{-} - {V}_{LO , D C} - {V}_{Tn , 4} - \frac{{V}_{LO}^{+} - {V}_{LO , D C}}{2} ) \\ ( {V}_{LO}^{+} - {V}_{LO , D C} ) ,\end{matrix} \qquad Eq .1$$

In Equation (1), βn is a value obtained by multiplying of W/L of each NMOSFET by μnCox. Therefore, a differential output may be written as follow:

Vₒᵤₜ⁺−Vₒᵤₜ⁻=R_{f} ((I¹−I₄)−(I³−I₂))=βR_{f}(V_{Rf}⁺−V_{Rf}⁻)(V_{LO}⁺−V_{LO}⁻) Eq. (2)

FIG. 1B is a schematic diagram of a conventional anti-parallel connection diode frequency mixer. In FIG. 1B, i1 and i2 may be written as follows:

i₁=−iₛ(e^{-aV}−1) Eq.(3)

i₂=iₛ(e^{-aV}−1)

Therefore, each conductance may be written as follow:

$${g}_{1} = \frac{ⅆ {i}_{1}}{ⅆ V} = {ai}_{s} {ⅇ}^{- aV} \\ {g}_{2} = \frac{ⅆ {i}_{2}}{ⅆ V} = {ai}_{s} {ⅇ}^{aV} \qquad Eq . ( 4 )$$

Therefore, the conductance of a total current may be written as follow:

g+g₁+g₂=αiₛe^{-αV}+αiₛe^{αV}=2αiₛ cosh αV Eq. (5)

If V=VLOCOS(_Lot) +VRFCOS(_RFt) is applied to an anti-parallel diode pair (APDP), then an output current may be written as follow:

I=g(V_{LO}cosω_{LO}^{t}+V_{RF}cosω_{RF}^{t}) Eq. (6)

=Acosω_{LO}^{t}+Bcosω_{RF}^{t}+Ccos3ω_{LO}^{t}+Dcos5ω_{LO}^{t}+Ecos(2ω_{LO}+ω_{RF})^{t}+F cos(2ω_{LO}−ω_{RF})^{t}+Gcos(4ωhd LO+_{RF})^{t}+Hcos(4ω_{LO}−ω_{RF})^{t}+Λ

FIG. 1C is diagram illustrating characteristics of the frequency mixer in FIGS. 1A and 1B.

The mixer shown in FIG. 1A needs to use whole frequency of a local oscillator for mixing frequencies. In case of utilizing the mixer to a homodyne transceiver, the mixer has problems that the DC voltage is generated, and a local oscillator of the radio frequency is needed for increasing radio frequency.

The mixer shown in FIG. 1B also has the DC voltage offset problem causing by representing a fundamental frequency of the applied frequency to output even it mixes twice frequency of an applied frequency of a local oscillator.

### SUMMARY OF THE INVENTION

It is, therefore, an object of the present invention to provide a frequency mixer reducing necessary frequency of a local oscillator by half in a radio frequency heterodyne transceiver and eliminating DC voltage offset in a homodyne transceiver with using a frequency mixer.

In accordance with an aspect of the present invention, there is provided a frequency mixer for a radio frequency transceiver, including: two NMOS transistors, which are commonly connected, for generating a mixed signal combined with even harmonics, wherein a first end of the NMOS transistors is input a radio frequency signal, a second end of the NMOS transistors outputs the mixed signal, and gates of the NMOS transistors receive differential signals of local oscillator.

In accordance with another aspect of the present invention, there is provided a frequency mixer of radio frequency transceiver having radio frequency of local oscillator as an input, including; a first, second input end for receiving an input as differential signal being said radio frequency signal; a first mixer unit consisted with parallel structure of a first, second NMOS transistor, wherein said source is commonly connected to said first input, said drain is commonly connected, and gates is input differential signal being radio frequency signal; and a second mixer unit consisted with parallel structure of a third, fourth NMOS transistor, wherein said source is commonly connected to said second input end, said drain is commonly connected, and gates are input differential signal being said radio frequency signal.

### BRIEF DESCRIPTION OF THE DRAWINGS

The above and other objects and features of the present invention will become apparent from the following description of the preferred embodiments given in conjunction with the accompanying drawings, in which:

FIG. 1A is a schematic diagram of a conventional passive frequency mixer using n type MOSFET;

FIG. 1B is an equivalent circuit diagram of an anti- parallel connect diode mixer;

FIG. 1C is a graph for showing characteristics of the mixer as shown in FIG. 1B;

FIG. 2A is a schematic diagram of a half local oscillation frequency mixer in accordance with the present invention;

FIG. 2B is a graph for illustrating trans conductance of half local oscillation frequency mixer in accordance with an embodiment of the present invention;

FIG. 2C is a spectrum graph for illustrating trans conductance of the half local oscillation frequency mixer in FIG. 2A;

FIG. 3A is a schematic diagram of a differential frequency mixer in accordance with another embodiment of the present invention; and

FIG. 3B is a spectrum graph of the mixer in FIG. 3A.

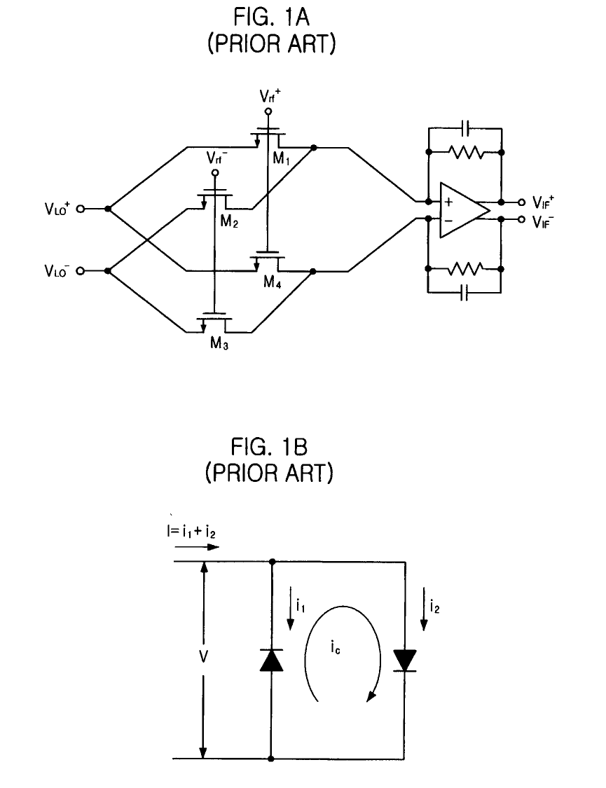

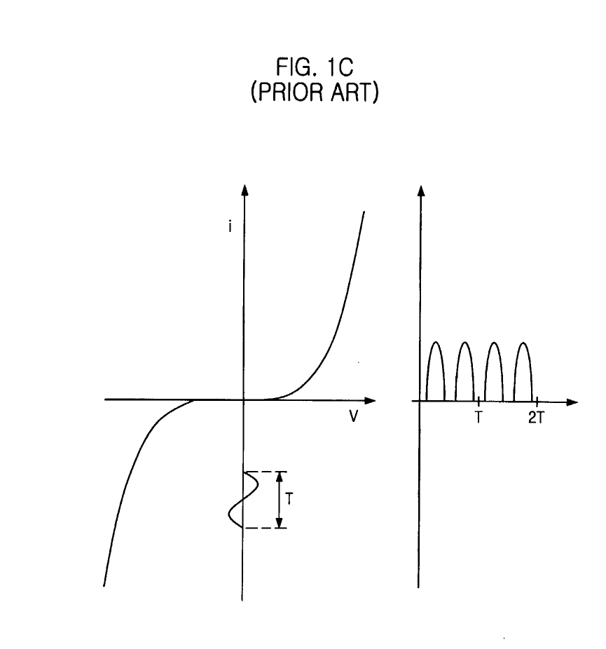

### PREFERRED EMBODIMENTS OF THE INVENTION

In the preferred embodiment of the present invention, two output points are tied up as a one by using two n-type MOSFETs. Therefore, the mixer of the present invention can mix frequencies with using a half of a local oscillation frequency by a virtual frequency of a local oscillator, which is twice of a fundamental frequency of the local oscillator, while suppressing the fundamental frequency.

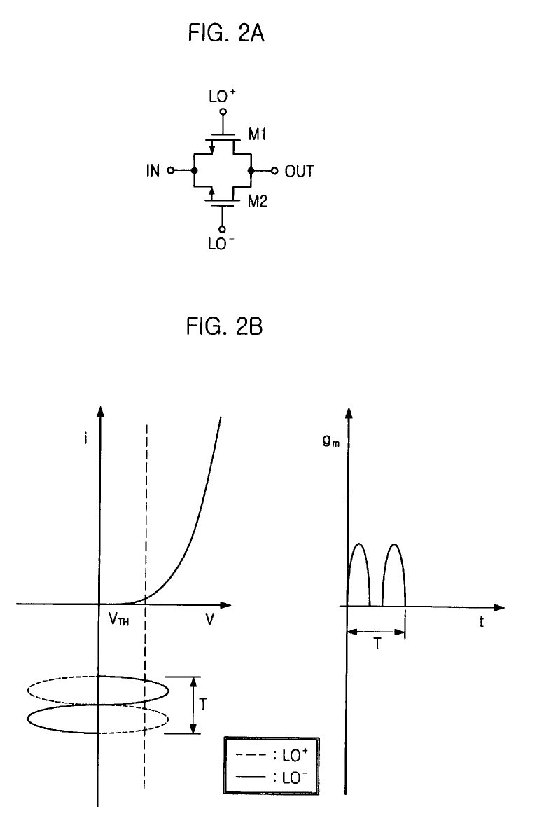

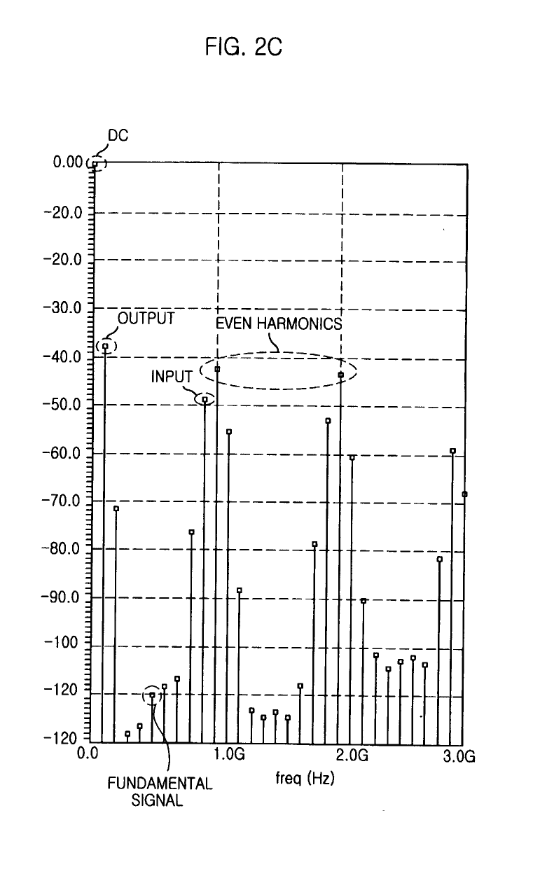

FIG. 2A is a schematic diagraph of a passive frequency mixer using an N-type MOSFET in accordance to the present invention. FIG. 2B illustrates trans conductance of the passive frequency mixer of the present invention.

Referring to FIG. 2A, the passive frequency mixer includes a first NMOS transistor M1 and a second NMOS transistor M2. The first NMOS transistor M1 is composed of a source connected to an IN, a drain connected to an OUT, and a gate receiving a positive (+) signal of the local oscillator (hereinafter, which is referred to as LO+). The second NMOS transistor M2 is composed of a source commonly connected to the source of the first NMOS transistor M1, a drain commonly connected to the drain of the first NMOS transistor M1, and a gate receiving a negative (+) signal of the local oscillator (hereinafter, which is referred to as LO−).

Referring to FIG. 2B, LO+ and LO− have 180 degree topological difference and are generated both within a time period T.

As described above, in a frequency mixer with parallel connected two NMOS transistors, the first NMOS transistor M1 turns on when LO+ is applied to the gate of the first NMOS transistor M1 and a voltage of the LO+ is lager than a threshold voltage VT.

At this time, LO− is applied to the gate of the second NMOS transistor, and then the second NMOS transistor M2 turns off.

After then, as passing half period (T/2), the first and second NMOS transistors M1, M2 are turned off, and then the second NMOS transistor M2 is turned on again by LO−.

Two parallel-connected NMOS transistors operate alternately on half period time of the applied signal by the signal applied to each of their gates. Therefore, it can have trans-conductance as shown in FIG. 2B.

FIG. 2B illustrates that the fundamental frequency of applied local oscillation frequency is not generated.

The trans-conductance may be expressed as Fourier series as follow:

f(t)=A−Bcos(2ω_{LO}t)−Ccos(4ω_{LO}t)−D(6ω_{LO}t)Λ Eq. (7)

wherein, A,B,C and D are constants, ω^{LO} is a frequency of the local oscillator and t is time.

Therefore, if the input signal rf(t) is Arfcos(_rft) and LO(t) is Alocos(_lot) then, output signal[Out(1) may be written as follows:

Out(1)=f(t)[LO(t)−rf(t)−Vt]=[A−Bcos(2_lot)−Ccos(4_Lot)[Arfcos(_{—}rft)−Alocos(₋ot)−VT] Eq. (8)

Out(t)=DC+A′cos(_{—}rft)+B′cos(2_lot)+C′cos(4_lot) +D′cos[(2_{—}lo−_{—}rf)t+E′cos[(2_{—}lo+_{—}rf)t]+F′cos[(4_{—}lo−_{—}rf)t+G′cos[(4_{—}lo+_{—}rf)t]+Λ Eq. (9)

Therefore, the output signal Out(t) is combined with a mixed signal with applied fundamental frequency of local oscillator of even harmonics, which is D′cos[(2_lo−_rf)t+E′cos[(2_lo+_rf)t+F′cos[(4_lo−_rf)t +G′cos[(4_lo+_rf)t], a input signal radio frequency [A′cos(_rft)], even harmonics of the applied local oscillation frequency [B′cos(2_lot) +C′cos(4_lot)] and DC.

FIG. 2C illustrates output spectrum of Equation (3).

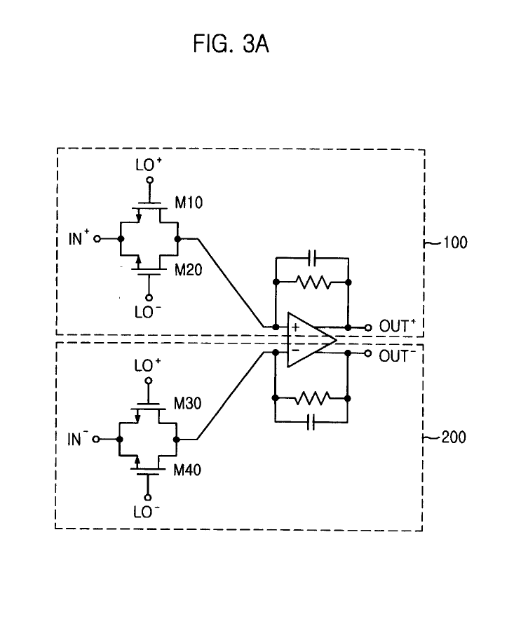

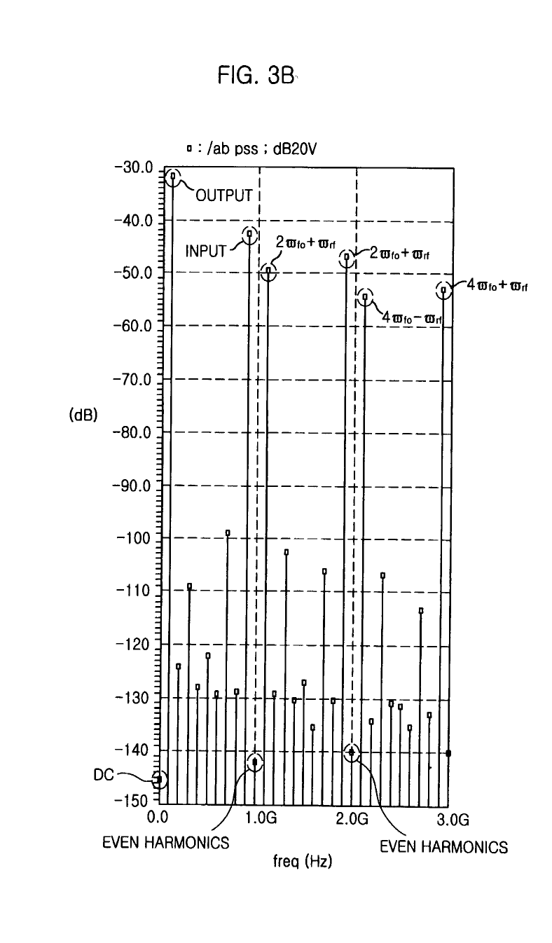

FIG. 3A is a schematic diagram of a differential structure of half local oscillation frequency MOSFET frequency mixer in accordance with another embodiment of the present invention.

Referring to FIG. 3A, the differential structure of mixer includes a first mixer unit 100 and a second mixer unit 200. The first mixer unit 100 has a structure of parallel connected a first and second NMOS transistors M10, M20, wherein a first input IN⁺ receives a positive (+) radio frequency signal, a source is commonly connected to the first input IN⁺ and a drain is commonly connected to a first output OUT⁺. In the first mixer unit 100, a gate of the first NMOS transistors M10 receives a positive (+) signal LO+ of a local oscillator LO and a gate of the second NMOS transistor M20 receives a negative (−) signal LO− of the local oscillator LO. The second mixer unit 200 has a structure of parallel connected a third and fourth NMOS transistors M30, M40 connected in parallel wherein a second input IN⁻ receives a negative (−) radio frequency signal LO−, a source is commonly connected to the second input IN⁻, and a drain is commonly connected to a second output OUT⁻. In the second mixer unit, a gate of the third NMOS transistor M30 receives a positive (+) signal LO+ of a local oscillator LO, and a gate of the fourth NMOS transistor M40 receives a negative (−) signal LO− of the local oscillator LO.

According to above described structure, the first NMOS transistor M10 and the second NMOS transistor M20 are operated as a positive (+) signal IN⁺ of radio frequency mixer and the third NMOS transistor M30 and the fourth NMOS transistor M40 are operated as a negative (−) signal IN⁻ of the radio frequency mixer.

Therefore, OUT⁺ and OUT^{—} of each output of two mixer is expressed as follows:

OUT⁺⁼DC+A′cos(_{—}rft)+B′cos(2_lot)+C′cos (4_lot) +D′cos[(2_{—}lo−₁₃ rf)t]+E′cos[(2_{—}lo+_{—}rf)t]+F′cos[(4_{—}lo−_{—}rf)t]+G′cos[(4_{—}lo+_{—}rf)t]+ΛOUT=DC+A′cos(_{—}rft)+B′cos(2_lot)+C′cos(−F′cos[(4_{—}lo−_{—}rf)t]−G′cos[(4_{—}lo+_{—}rf)t]+Λ Eq. (10)

Referring to Equation (10), differential signals of two outputs can be obtained and according to Equation 11, a DC voltage offset and a radio frequency of fundamental frequency of local oscillator can be eliminated and only a mixed signal of radio frequency and a frequency of local oscillator can be obtained.

(OUTˆ +)−OUTˆ −)=D′cos[(2_{—}lo−_{—}rf)]t+E′cos[(2_{—}lo+_{—}rf)]t +F′cos[(4_{—}lo−_{—}rf)]t+G′cos[(4_{—}lo+_{—}rf)]t+Λ Eq.(11)

FIG. 3B illustrates output spectrum of a differential signal of two mixer described on FIG. 3A.

Referring to FIG. 3B, according to the differential signal of the two mixer, an output is a mixed signal such as (2_lo−_rf), (2_lo+_rf), (4_lo−_rf) and (4_lo+_rf).

While the present invention has been described with respect to certain preferred embodiments, it will be apparent to those skilled in the art that various changes and modifications may be made without departing from the scope of the invention as defined in the following claims.

What is claimed is:

1. A frequency mixer for a radio frequency transceiver, comprising:
two NMOS transistors, which are commonly connected, for generating a mixed signal combined with even harmonics, wherein a first end of the NMOS transistors receives a radio frequency signal, a second end of the NMOS transistors outputs the mixed signal, and gates of the NMOS transistors receive differential local oscillation signals from a local oscillator.

2. The frequency mixer as recited in claim 1, wherein said first end is a source and said second end is a drain.

3. A frequency mixer of a radio frequency transceiver, comprising:
a first and a second input ends for receiving input signals which are differential radio frequency signals;
a first mixing means having a parallel structure of a first and a second NMOS transistors, for generating a first mixed signal, wherein a first end of the first and second transistors are commonly connected to said first input end, a second end of the first and second transistors are commonly connected, and gates of the first and second transistors receive differential local oscillation signals; and
a second mixing means having a parallel structure of a third and a fourth NMOS transistors, for generating a second mixed signal, wherein a first end of the third and fourth transistors are commonly connected to said second input end, a second end of the third and the fourth transistors are commonly connected, and gates of the third and fourth transistors receive the differential local oscillation signals.

4. The frequency mixer as recited in claim 3, wherein said first end is a source and said second end is a drain.
